(19) United States
(12) Patent Application Publication
(10) Pub. No.: US 2005/0282560 A1
(43) Pub. Date: Dec. 22, 2005

(54) FM based radio data system information data messaging

(75) Inventor: Jackson Wang, Toronto (CA)

Correspondence Address: JONES DAY, 222 EAST 41ST ST, NEW YORK, NY, 10017, US

(73) Assignee: e-Radio USA, LLC

(21) Appl. No.: 10/869,262

(22) Filed: Jun. 16, 2004

(51) Int. Cl. H04Q 7/20

(52) U.S. Cl. 455/456.6; 455/456.1

(57) ABSTRACT

A data messaging system is provided utilizing the FM based radio data system that utilizes existing RDS receiver hardware enabled to receive location specific traffic and/or weather information. An extensible markup language (XML) is used to enable the existing hardware capabilities of RDS capable FM radios. Utilization of XML technology will allow RDS display of various applications that are language independent, particularly, real time data messaging of traffic messages generated as XML output.

### RELATED APPLICATIONS

There are no previously filed, nor currently any co-pending applications, anywhere in the world.

### BACKGROUND OF THE INVENTION

1. Field of the Invention

The present invention relates generally to radio data system and, more particularly, to an FM based data messaging system using existing RDS receivers for receiving location specific traffic or weather information.

2. Description of the Related Art

In order to describe the complete relationship of the invention, it is essential that some description be given to the manner and practice of functional utility and description of radio broadcast data system (RBDS). The standards for this system are best described in the “United States RBDS Standard” by the National Radio Systems Committee of the National Association of Broadcasters, as described in USPTO form PTO-1440 and incorporated by reference herein as if fully rewritten.

The development of RDS started some 20 years ago in the European Broadcasting Union, EBU. The developers aimed at making radio receivers very user-friendly, especially car radios when these are used where a transmitter network with a number of alternative frequencies (AF) are present. In addition listeners should be enabled to see the program service name (PS) on an eight character alpha-numerical display and the transmitter frequency information, displayed on non-RDS radios, is then only used, in the background, by an RDS radio. All this has become possible by the using, for many years, microprocessor controlled PLL tuner technology, permitting a radio to be re-tuned within milliseconds. During this process the audio signal is muted which because of the short time is usually not detected by the ear. Thus, the radio is able to choose the transmitter frequency, among a number of alternatives, that gives the best quality reception. It is also sure that the switch-over is made to exactly the same program service by performing a kind of identity check using the program identity (PI) code.

The use of more and more frequencies for radio programs in the VHF/FM range make it increasingly difficult to tune a conventional radio to a desired program. This kind of difficulty is solved with the Radio Data System, that has been on the market since 1987, and whose evolution is still continuing.

In the prior art, travel information with RDS is possible using the Travel Program (TP) and Travel Announcement (TA) flags. Information is broadcast for motorists, identified in parallel with the ARI system with the corresponding RDS features TPITA. But ARI is being replaced on a European scale, so it will cease after the year 2005. A more recent development of RDS is the digitally coded Traffic Message Channel (TMC) which is now planned to be introduced all over Europe, within projects funded by the European Union. However, present RDS radios are not yet suitable for RDS-TMC for use in the United States.

Consequently, a need has been felt for providing a method of providing real time traffic information via data messaging utilizing FM based real time data messaging system using existing RDS receivers.

### SUMMARY OF THE INVENTION

It is therefore an object of the present invention to provide an improved FM based radio data system data messaging system.

It is a feature of the present invention to provide real time traffic message control delivered to existing, unmodified RDS receivers.

Briefly described according to one embodiment of the present invention, a data messaging system is provided utilizing the FM based radio data system that utilizes existing RDS receiver hardware enabled to receive location specific traffic and/or weather information. An extensible markup language (XML) is used to enable the existing hardware capabilities of RDS capable FM radios. Utilization of XML technology will allow RDS display of various applications that are language independent, particularly, real time data messaging of traffic messages generated as XML output.

In accordance with a preferred embodiment, an FM based data messaging system can be created using existing RDS receivers for receiving location specific information

An advantage of the present invention is that it can be adapted for use with a variety of location specific information, such as weather, traffic, or the like, without any hardware modification.

Another advantage of the present invention is that it can be enable without any hardware modification to existing RDS enabled receivers currently on the road in most late-model vehicles.

Yet another advantage of the present invention is that it can develop eventual text messages from any existing open source information stream.

Yet another advantage of the present invention is that it utilizes XML technology will allow RDS display of various applications that are language independent.

Yet another advantage of the present invention is that it can be used to enable a new information transmission grid.

Yet another advantage of the present invention is that it is capable of being nationally coordinated, but locally distributed.

Further, a preferred embodiment of the present invention has the capability of being the foundation for a more specific data messaging system implemented using a vehicle located FM receiver as the text display mechanism.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a block diagram of an FM based data messaging system using existing RDS receivers for receiving location specific information; and

FIG. 2 is a functional schematic diagram thereof.

### DESCRIPTION OF THE PREFERRED EMBODIMENTS

The best mode for carrying out the invention is presented in terms of its preferred embodiment, herein depicted within the Figures.

### 1. Detailed Description of the Figures

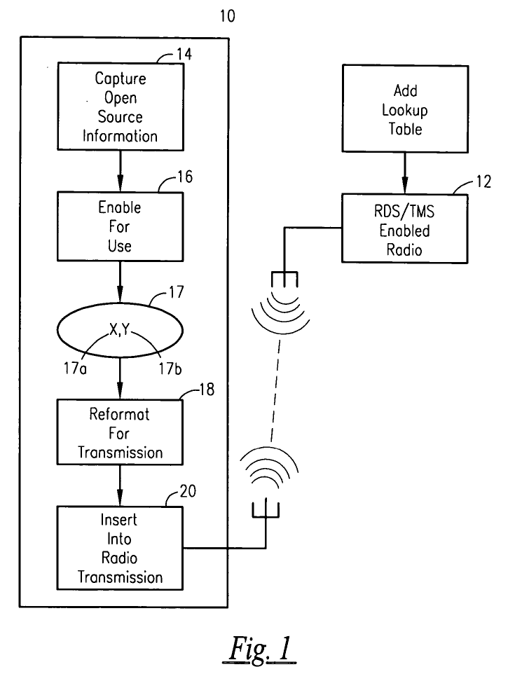

Referring now to FIG. 1, a data messaging system 10 is generally described anticipated as utilizing the FM based radio data system (RDS) that utilizes existing RDS receiver hardware 12. Although such a receiver 12 is already enabled to receive data transmitted in an RDS-TMC format, the receiver 12 must be modified to give meaning to the received data. This modification is described in greater detail below. The origin of the data that functions as the initial source for the eventual text message is anticipated as being an open source information stream 14. Data standards currently exist for the characterization and providing of traffic information. However, it is anticipated that other similar data streams can be substituted analogously, such as weather data, “amber alert” information, or the like. In any event, the raw or previously processed information from the open source information stream 14 is then enable for use 16 by converting it from generic content to a series of binary data packets 17 each consisting of a location code 17a tied to an event code 17b. The location code 17a would be fixed to a specific geographic point, and would be linked to the event code 17b corresponding to a reported event at that specific location. The event code 17b would correspond a specific reportable event of interest occurring a that specific location. By way of example, but not as a limitation, in a traffic reporting scenario a location code representing the interchange of Interstate 95 and Interstate 295 would be given a fixed location code, with reportable events corresponding to real-time activity at that location being selected from a pre-determined table incorporating a comprehensive list of reportable events. These can include “lane closures”, “accidents”, “disabled vehicles” or other type of obstructions, as well as link impedance determinations such as “traffic at 30% capacity” or “traffic moving at 45 mph” type of standard Traffic and ravel Information (TTI). Once the data is enabled for use 16 into linked event codes and location codes, it is reformatted to be accommodated by the transport infrastructure 18. Next, the reformatted data is inserted into the radio transmission stream 20 for transmission within the RDS envelop, or otherwise adapted for a particular transportation infrastructure.

Finally to the general description of the present invention, the receiver 12 that already enabled to receive data transmitted in an RDS-TMC format is modified to give meaning to the received data. This is accomplished by adding within its memory a lookup table storing the pre-determined comprehensive list of reportable event codes as well as adding within its memory a lookup table storing a pre-determined required list of location codes. By encoding these lookup tables, the radio will be able to interpret and display meaningful text transmissions utilizing a modification of the existing RDS-TMC method.

### 2. Operation of the Preferred Embodiment

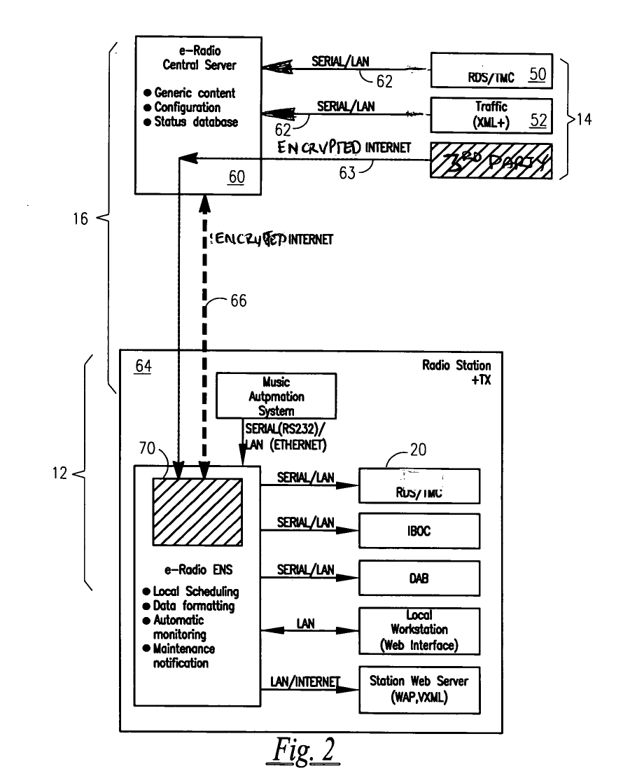

In accordance with a preferred embodiment of the present invention, as shown in FIG. 2, a particular application of the present system is shown for purposes of describing a preferred embodiment of the present invention. As is shown, the present system can be used for an open source information stream such a weather 50, traffic 52, or other specialized open source, or proprietary data specialized for a particular purpose 54. It is anticipated that current data standards that utilize an extensible markup language (XML) currently exist, and would therefore be adopted, thereby allowing the present invention to become immediately deployable, but also to allow for future changes or additions, such as changes in event terminology, as well as migration of existing terminology to various language translations. In any event, the data source 50 is communicated to a central server 60 via any traditional communication means 62, herein shown as a standard Internet™ or secure socket layer (SSL) Internet™ connection 63. The central server 60 receives the generic content and enables it for use 16 and forwards the content to a distributed network server 64, after performing three general functions:

a. Validating of the generic information. The information is checked for quality and consistency. Further, not all the data that is received will necessarily be broadcasted, so the central server 60 will remove unqualified data or events

b. Reformatting for Broadcast. Not all the data that is received will necessarily be broadcasted, so the central server 60 will remove unqualified data or events. Further, the data will be enabled for use into linked event codes and location codes.

c. Filtering for Specific Distributed Network Server. Data for all locations will not need to be transmitted to every distributed network server 64. Therefore, the central server 60 will filter the entire pool of data and sort by relevant Distributed network server general location.

The validated, formatted and filtered data 66 is transmitted to one of potentially many distributed network servers 64, each of which would reformat the data to be accommodated by the transport infrastructure 18, and insert the data into the radio transmission stream 20 for transmission within the RDS envelop. This can done at the local radio station level through the use of an e-Radio TIC-XML converter 70, or equivalent. Alternately, it can also be done at the central server level.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents. By way of example, and not as a limitation, it is anticipated that the present method for utilizing an FM based data messaging system using existing RDS receivers for receiving location information can be adapted or modified for receiving alternate text data by utilizing an extensible markup language (XML) to enable the existing hardware capabilities of RDS capable FM radios. Utilization of XML technology will allow RDS display of various applications that are language independent, particularly, real time data messaging of traffic messages generated as XML output.

Therefore, the scope of the invention is to be limited only by the following claims.

1. A method for enabling an FM based data messaging system using existing RDS receivers for receiving location specific information, said method comprising the steps:
a. Enable an information stream for use by converting it from generic content to a series of binary data packets each consisting of a location code and an event code;
b. Linking each event code to a specific location code; and
c. Reformatting said enabled information to be accommodated by the transport infrastructure.

2. The method of claim 1, further comprising the steps:
a. Inserting said enabled information into the radio transmission stream for transmission within the RDS envelop.

3. The method of claim 1, wherein in linking each event code to a specific location, said location code would be fixed to a specific geographic point, and would be linked to said event code corresponding to a reported event at that specific location.

4. The method of claim 1, wherein said event code would correspond a specific reportable event of interest occurring at a specific location.

5. The method of claim 4, wherein said event code is selected from a group comprising: travel and traffic information; weather information; and amber alert information.

6. The method of claim 2, further comprising the step:
modifying an RDS-TMC format compatible radio to give meaning to the received data enabled information.

7. The method of claim 6, wherein said modification comprises:
adding within a radio's memory a lookup table storing the pre-determined comprehensive list of reportable event codes as well as adding within its memory a lookup table storing a pre-determined required list of location codes, wherein by encoding these lookup tables, the radio will be able to interpret and display meaningful text transmissions utilizing a modification of the existing RDS-TMC method.

8. An information grid comprising:
a macro-coordinated information stream;
communication means for communicating said information a central server;
a central server for receiving content and enabling it for use and forwarding the content to a distributed network server;
at least one distributed network server for reformatting the data to be accommodated by a transport infrastructure; and
at least one RDS-capable FM radio receiver.

9. The information grid of claim 8, wherein said communication means is selected from the group comprising : a standard Internet™ connection; and, an encrypted Internet™ connection.

10. The information grid of claim 8, wherein said central server further validates said information.

11. The information grid of claim 8, wherein said central server further checks said information for quality and consistency.

12. The information grid of claim 8, wherein said central server further filters said information, thereby removing any unqualified data or events.

13. The information grid of claim 8, wherein said central server further reformats said information for broadcast by enabling for use by linking event codes and location codes.

14. The information grid of claim 12, where said the central server will filter the entire pool of data and sort by relevant distributed network server general location.

15. The information grid of claim 8, wherein:
said transmission infrastructure comprises an FM radio transmission means; and
said distributed network server inserts the data into the radio transmission stream for transmission within the RDS envelop.

16. The information grid of claim 8, wherein said RDS-capable FM radio receiver is modified by adding within said radio's memory a lookup table storing the pre-determined comprehensive list of reportable event codes as well as adding within its memory a lookup table storing a pre-determined required list of location codes.
